(19) United States
(12) Patent Application Publication
(10) Pub. No.: US 2015/0137521 A1
(43) Pub. Date: May 21, 2015

(54) AIR POWERED ELECTRICITY GENERATING SYSTEM

(71) Applicant: Gabriel Ohiochioya Obadan, Huntington Beach, CA (US)

(72) Inventor: Gabriel Ohiochioya Obadan, Huntington Beach, CA (US)

(21) Appl. No.: 14/547,039

(22) Filed: Nov. 18, 2014

Related U.S. Application Data
(60) Provisional application No. 61/905,847, filed on Nov. 19, 2013.

(51) Int. Cl. H02K 7/18; F01D 13/02

(52) U.S. Cl. CPC H02K 7/1823; F01D 13/02; Y10S 415/916; H02K 53/00
USPC 290/52; 415/916

(57) ABSTRACT

A pneumatic turbine system generates electricity utilizing electrical energy input to produce a constant flow of air that is compressed into pneumatic energy which is transformed into mechanical energy to produce electrical energy so that overall energy output resulting from the combined forces of wind, pneumatic, electrical, and mechanical energy is greater than electrical energy input. A multi-compression chamber comprising a starter motor and air intake turbine draws air into a housing and pressurizes the air. A jet propulsion corridor further pressurizes air utilizing nozzles where air is transferred to an electricity-generating turbine corridor having micro-compression turbines mounted on a shall that is connected to a stabilizing motor and an electric generator. The micro-compression turbines further compress the air and transfers mechanical energy to a generator. The housing redirects excess air back into the system.

This application claims the benefit of the filing date of provisional application No. 61/905,847, filed on Nov. 19, 2013.

### BACKGROUND

This invention relates to a system for electric energy output utilizing a collective synergy of several forms of energy: wind, mechanical, electrical, and pneumatic.

Known is the wind turbine, which is a device that converts kinetic energy from the wind (wind energy) into mechanical energy. This process is known as wind power. Wind turbines are used to produce electrical power from the energy contained in blowing wind. The wind turbine comprises a rotor which is driven by the wind and which in turn drives an induction generator, which is usually an AC generator. However, users of this type of energy generation are at the mercy of unpredictable wind patterns. As wind speeds decline or cease, so does the power output of the wind turbine. A system that can rely upon a constant source of wind energy would be desirable. However, naturally occurring wind cannot be manipulated.

The present invention overcomes this shortcoming by first utilizing electrical energy to create wind energy. The wind is compressed thereby producing pneumatic energy that is then transformed into mechanical energy to produce electrical energy. More specifically, ambient air is drawn into a Multiple-Compression Chamber with the assistance of an electrical starting motor and Air Intake Turbines. The ambient air is pressurized and pushed into a Jet-Propulsion Corridor by the Air Intake Turbines. In the Jet-Propulsion Corridor, jet nozzles create pneumatic energy that is directed to an Electricity-Generating Turbine Corridor. There, shaft mounted Micro-compression Turbines with a sail configuration rotate and create additional pneumatic energy by collecting and further compressing the incoming Jet-Propulsion Corridor airflow. The compressed air causes the Micro-compression Turbines to rotate and transfer mechanical energy to a generator through a rotating shaft. The generator converts torque output into electricity. Excess air is recycled back into the system while some air is released back into the environment through decompression vents to alleviate pressure in the system. Once the system begins to generate power, the starter motor electricity demand is reduced to maintain constant rotation of the Air Intake Turbine. In this way wind energy is constantly maintained while the system's demand for electrical energy is reduced. Overall, the energy input required to start and maintain a constant flow of wind is less than the energy output of the combined forces of wind, pneumatic, and mechanical energy. Testing of an embodiment of the present invention have shown that 100 kilowatts of electricity input can generate 150 kilowatts of electrical output.

### SUMMARY

The present invention is a Air Powered Electricity Generating System. The system utilizes electrical energy input to produce a constant flow of air that is compressed into pneumatic energy that is transformed into mechanical energy to produce electrical energy.

This is accomplished with the help of an electrical starting motor and Air intake Turbines that draw ambient air into a housing for the system. The ambient air is pressurized and pushed into a Jet-Propulsion Corridor by the Air Intake Turbines. In the Jet-Propulsion Corridor, jet nozzles create pneumatic energy that is directed to an Electricity-Generating Turbine Corridor. There, shaft mounted Micro-compression Turbines having a sail configuration rotate and create additional pneumatic energy by collecting and further compressing the incoming Jot-Propulsion Corridor airflow. The compressed air causes the Micro-compression Turbine to rotate and transfer mechanical energy to a generator through a rotating shaft. The generator converts torque output into electricity.

Excess air is recycled back into the system while some air is released back into the environment through decompression vents to alleviate pressure in the system. Once the system begins to generate power, the starter motor electricity demand is reduced to maintain constant rotation of the Air intake Turbine.

Overall, the energy input required to start and maintain a constant flow of wind is less than the energy output of the combined forces of wind, pneumatic, and mechanical energy.

### BRIEF DESCRIPTION OF THE FIGURES

FIG. 1 illustrates a cross-sectional view of an electricity-generating system embodying features of the present invention for an Air Powered Electricity Generating System.

FIG. 2A illustrates a cross-sectional view of an alternate embodiment of an electricity-generating system embodying features of the present invention for an Air Powered Electricity Generating System.

FIG. 2B illustrates a sectional view of a multiple-compression chamber for an electricity-generating system embodying features of the present invention for an Air Powered Electricity Generating System.

FIG. 2C illustrates a sectional view of a jet-propulsion corridor for an electricity-generating system embodying features of the present invention for an Air Powered Electricity Generating System.

FIG. 2D illustrates a sectional view of an electricity-generating turbine corridor with stabilizing motor and generator for an electricity generating system embodying features of the present invention for an Air Powered Electricity Generating System.

FIG. 3 illustrates a cross-sectional view of the air flow within an electricity generating system embodying features of the present invention for an Air Powered Electricity Generating System.

FIG. 4 illustrates a cross-sectional view of a pressurized air conduit and housing for an electricity generating system embodying features of the present invention for an Air Powered Electricity Generating System.

FIG. 5 illustrates a sectional view of a jet-propulsion corridor and electricity-generating turbine corridor in series for an electricity-generating system embodying features of the present invention for an Air Powered Electricity Generating System.

FIG. 6 illustrates a sectional view of a jet-propulsion corridor and electricity-generating turbine corridor with parallel micro-compression turbines for an electricity-generating system embodying features of the present invention for an Air Powered Electricity Generating System.

FIG. 7 illustrates a cross-sectional view of an alternate embodiment of an electricity-generating system with multiple level micro-compression turbines embodying features of the present invention for an Air Powered Electricity Generating System.

FIG. 8 illustrates a cross-sectional view of an alternate embodiment of an electricity-generating system with multiple level and parallel micro-compression turbines embodying features of the present invention for an Air Powered Electricity Generating System.

FIGS. 9A-B illustrates a perspective view of several embodiments of a micro-compression turbine embodying features of the present invention for an Air Powered Electricity Generating System.

FIG. 10 illustrates a sectional view of an embodiment of an air intake turbine embodying features of the present invention for an Air Powered Electricity Generating System.

FIG. 11 illustrates an exploded view of section A-A of the air intake turbine of FIG. 10.

FIG. 12 illustrates an alternative embodiment Air Powered Electricity Generating System wherein the multiple compression chamber is oriented vertically for east of transport and installation.

### DESCRIPTION

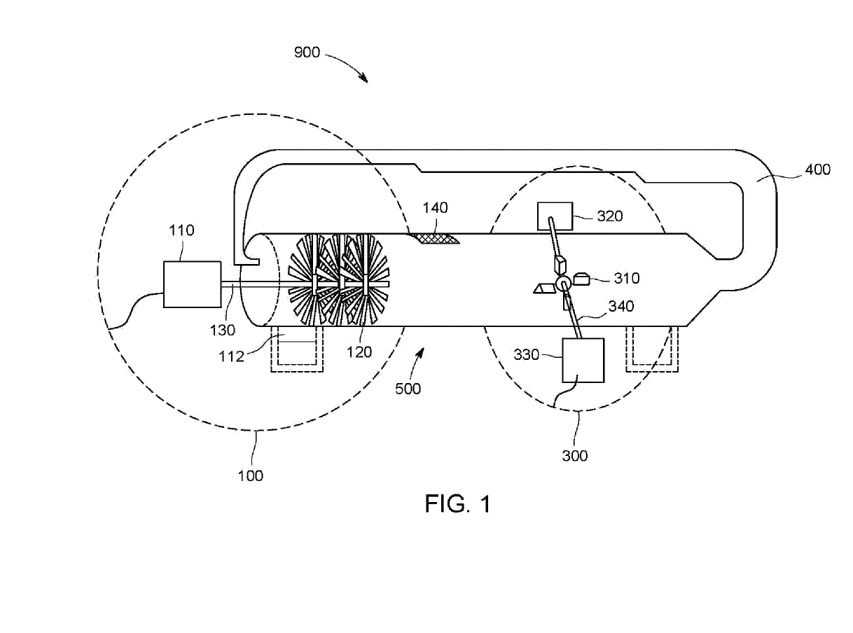

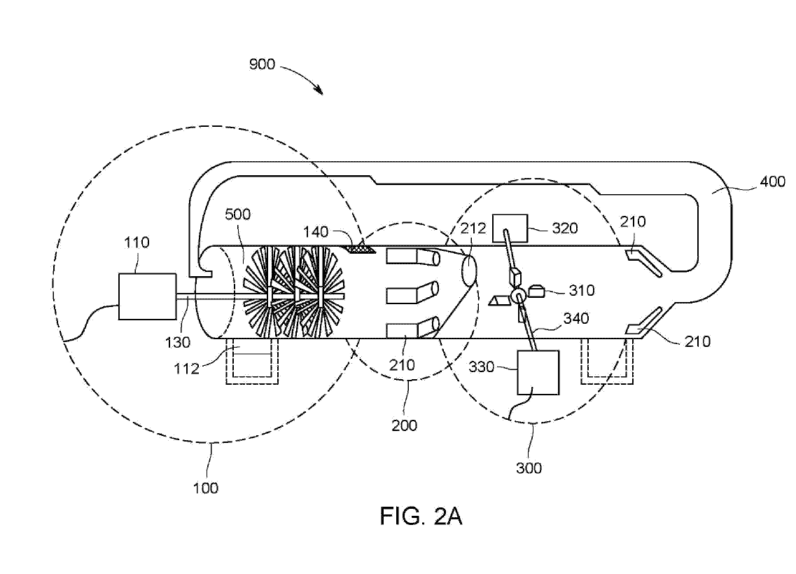

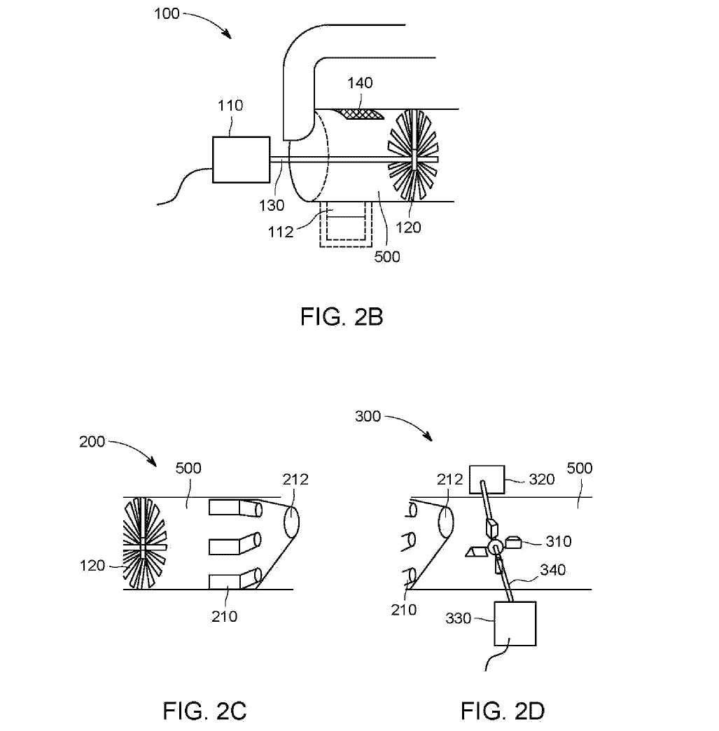

As shown FIGS. 1-9B, an Air Powered Electricity Generating System 900 is illustrated with a Multiple-Compression Chamber (MCC) 100, an electricity-generating Turbine Corridor (EGTC) 300, a Pressurized. Air Conduit 400, and a system housing 500, The Multiple-Compression Chamber 100, best illustrated in FIG. 2B, draws ambient air into the system housing where it is pressurized and pushed forward through the system.

A starting motor 110 and Intake turbine shall 130 drive an Air Intake Turbine 120 within the Multiple-Compression Chamber 100. The starting motor 110 assists with starting the system and maintains constant rotation of Air Intake Turbine 120. The starting motor 110, preferably rated at 100 H.P., is initially powered by an external source until the system begins to generate power whereupon it is powered by the Air Powered Electricity Generating System 900. Alternatively, rechargeable lithium-ion batteries 112, preferably rated at 150 AMPS, can be utilized to initially power the starting motor 110. As best illustrated in FIG. 1. the Air Intake Turbines 120 draw ambient air and air from the Pressurized Air Conduit 400 into the system housing 500 where it is pressurized and pushed into the Jet-Propulsion Corridor 200. In a preferred embodiment, a plurality of Air Intake Turbines 120 are mounted in series along the intake turbine shaft 130 to accelerate and pressurize the volume of air drawn into the system. In yet another preferred embodiment, the Air Intake Turbines 120 are mounted in pairs as illustrated in FIG. 1. The first of each Air Intake Turbine 120 pair draws in air and the Second Air Intake Turbine 120 of each pair pressurizes the air. In an alternate embodiment, illustrated in FIG. 10, the blades 122 of the Air Intake Turbine 120 include a flange 124 along the length of the blade 122. A pocket that can capture air is created where the angle between the blade 122 and flange 124 is less than 180 degrees. Referring to the sectional view illustrated in FIG. 11, each blade 122 may also terminate with a cap 125 that joins the distal ends of each blade 122 and flange 124 together. This cap 122 further increases the ability to retain captured air in each blades 122 pocket.

The pocket captures air entering the housing 500 from the Pressurized Air Conduit 400. When air entering the Multiple-Compression Chamber 100 from the Pressurized Air Conduit 400 is directed to the inside of the blade 122 and flange 124 pocket, the load on the starter motor 110 is reduced. When the load on the sinner motor 110 is reduced, the electricity draw by the system is also reduced, providing for higher efficiency. The quantity of Air Intake Turbines 120 is dependent on the system capacity and generator 330 utilized. Ambient Air Vents 140 on the Multiple-Compression Chamber 100 section of the system housing 500 provide additional areas to draw in ambient air.

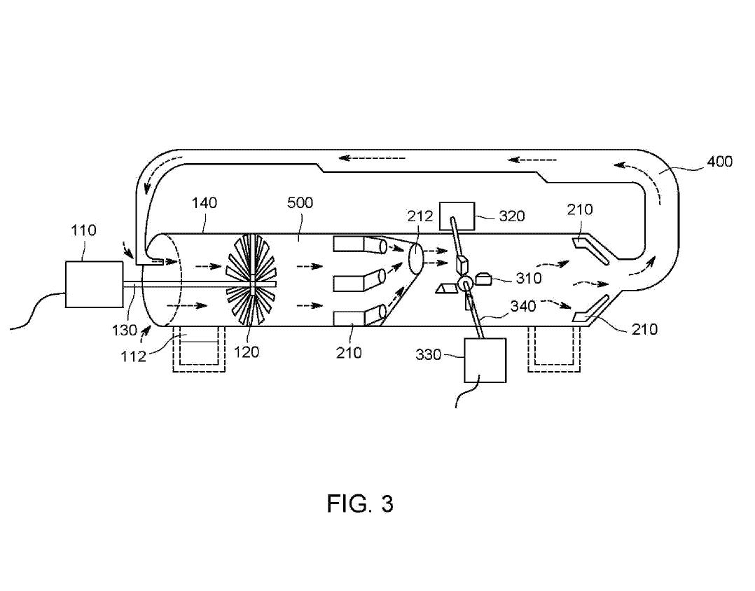

As illustrated in FIGS. 1 and 2A, the pressurized air is pushed forward through the system or into the Jet-Propulsion Corridor 200. In the Jet-Propulsion Corridor 200, jet nozzles 210 create wind energy by multiplying the air pressure. The highly pressurized air is directed into the Electricity-Generating Turbine Corridor 300 by the jet nozzles 210 and a secondary nozzle 212. As best illustrated in FIG. 3 the jet nozzles 210 multiply the velocity and density of the air by funneling and directing the airflow through the jet nozzles 210. A secondary nozzle 212 further concentrates the airflow into the concaved surface of the Micro-compression Turbines 310 inside of the Electricity-Generating Turbine Corridor 300.

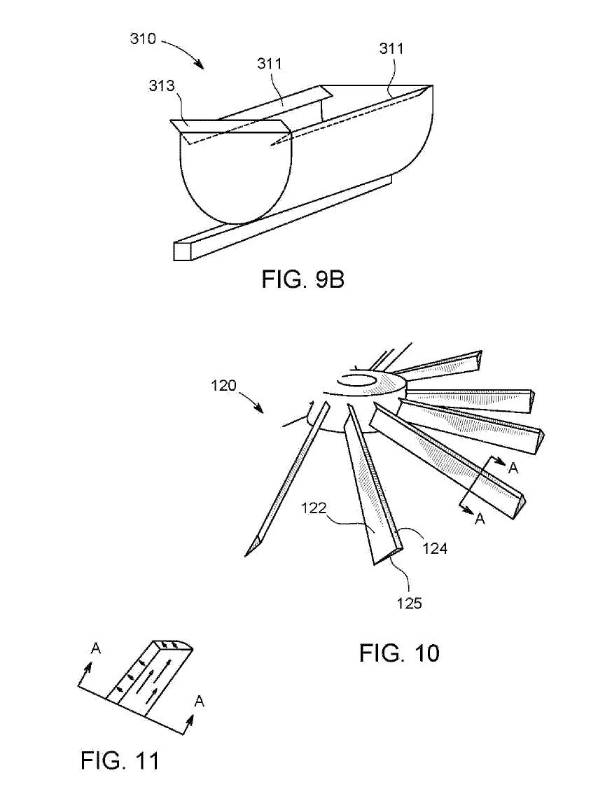

The Electricity-Generating Turbine Corridor 300, illustrated in FIGS. 2A and 2D, comprises Micro-compression Turbines 310 mounted on an Electricity-Generating Turbine Corridor Shaft (“EGTC Shaft”) 340. The EGTC Shaft 340 is perpendicular to the central axis of the Electricity-Generating Turbine Corridor 300 and is connected between a stabilizing motor 320 and generator 330. The EGTC Shah 340 allows the Micro-compression Turbines 310 to rotate and transfers mechanical energy to the generator 330. As best illustrated in FIG. 3, the Micro-compression Turbines 310 create mechanical energy by receiving high-pressure air from the jet nozzles 210 and causing a rotating torque on the EGTC Shaft 340. The torque is further increased by the Micro-compression Turbine 310 design efficiency. The Micro-compression Turbines 310 are preferably constructed of metal plates with a thickness sufficient to withstand large loads applied to them. Unlike typical turbines, the Micro-compression Turbines 310 comprise a concave sail design with inwardly folded side flanges 311 along the concave surface edges to create pneumatic energy by collecting and compressing the incoming Jet-Propulsion Corridor 200 airflow. Referring to FIGS. 9A-B, each Micro-compression Turbine 310 may include a closed bottom flange 312 or open bottom flange 313 to increase elliptical air propulsion. Where the Air Powered Electricity Generating Stem 900 does not include a Jet-Propulsion Corridor 200. the Micro-compression Turbines 310 with an open bottom flange 313 are employed. With these sail designs, 95% of the compressed air is collected.

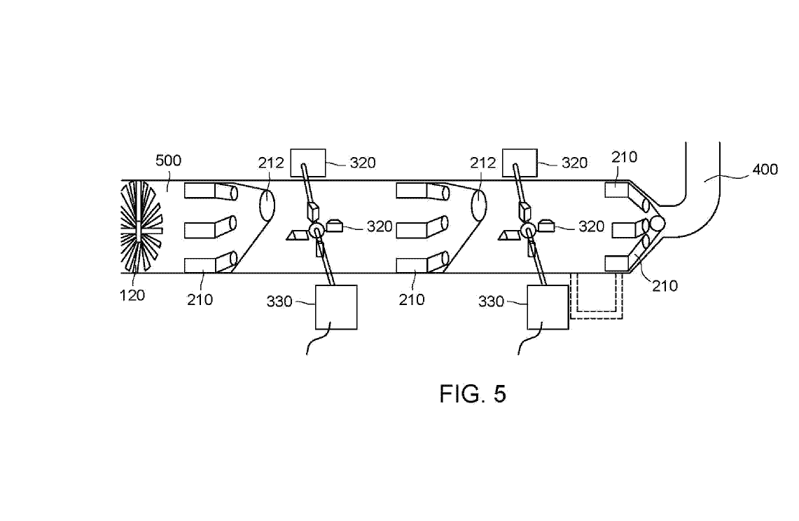

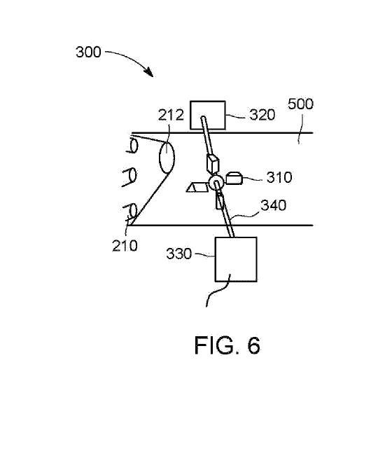

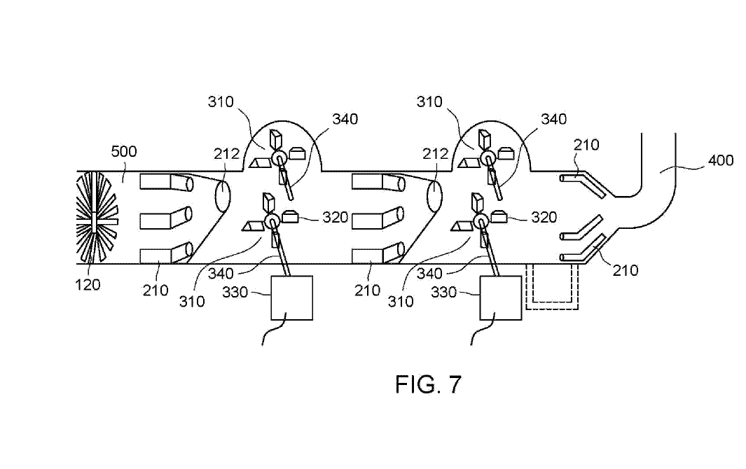

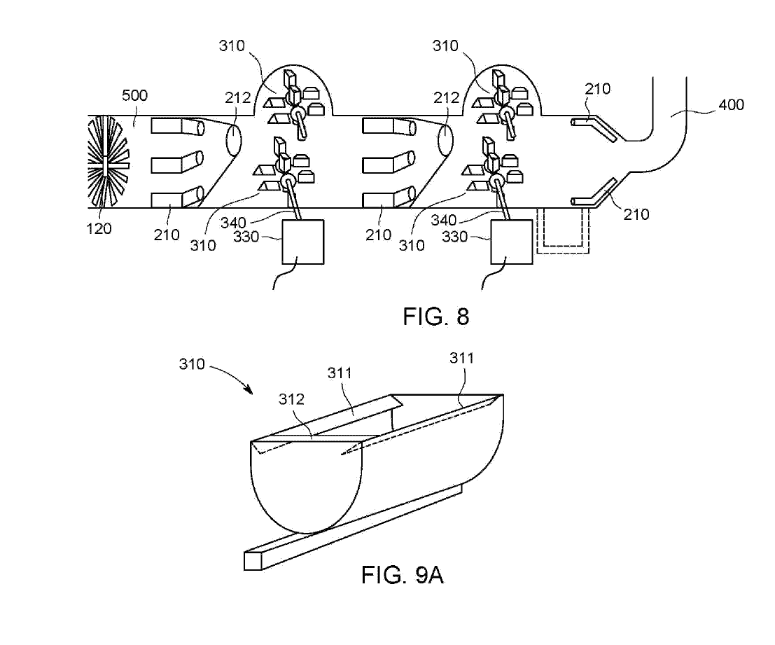

The stabilizing motor 320, best illustrated in FIG. 2D, is activated at the same time as the starter motor 110 to assist the generator 330 also mounted on the EGTC Shaft 340 maintain a constant and balanced rotation, preventing fluctuations in power to the generator. The stabilizing motor 320 also helps to maximize horsepower on the Micro-compression Turbines 310. When high-pressure air from the jet nozzles 210 makes contact with the Micro-compression Turbines 310, the amount or energy used by the stabilizing motor 320 decreases as the amount of energy produced by the generator 330 increases. Preferably, a 50 H.P. stabilizing motor 320 is utilized with a minimum rotation of 1,500 rpm and maximum rotation of 1800 rpm. The generator 330 converts the torque output (mechanical energy) from the Micro-compression Turbines 310 through the EGTC Shaft 340 into electricity. Preferably, a 190 kW energy input is utilized and requires 1,500-1,800 rpm to begin power generation resulting in a typical output or 250 kW. In an alternate embodiment, illustrated in FIG. 5, multiple sets of Micro-compression Turbines 310 with stabilizing motor 320 and generator 330 can be placed in series to achieve greater power output. When multiple sets of Micro-compression Turbines 310 are used in series, an additional Jet-Propulsion Corridor 200 must be placed before each set. In another alternate embodiment, illustrated in FIG. 6, multiple Micro-compression Turbines 310 are placed parallel to each other on a shared EGTC shaft 340. In another alternate embodiment, illustrated in FIG. 7, multiple Micro-compression Turbines 310 with stabilizing motor 320 and generator 330 are placed in a multi-level arrangement. In this arrangement, several stabilizing motors 320 and generators 330 are mounted upon one another. In yet another alternate embodiment, illustrated in FIG. 8, the Micro-compression Turbines 310 are placed in a multi-level arrangement as shown in FIG. 7, but with additional Micro-compression Turbines 310 laterally mounted on the EGTC shaft 340.

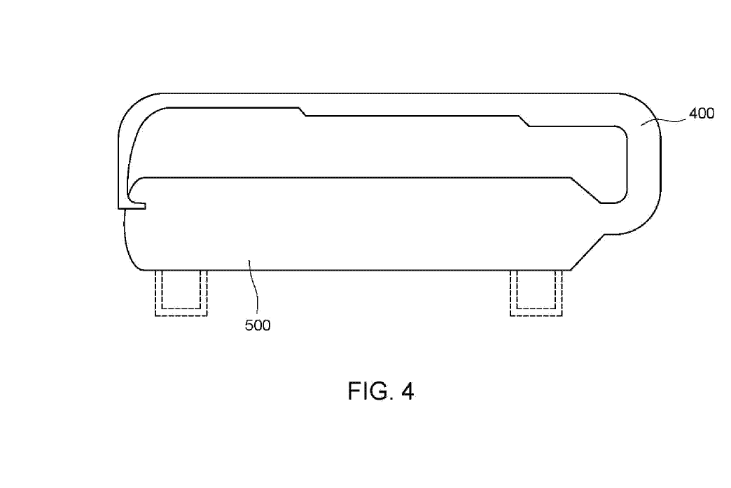

FIG. 4 illustrates the Pressurized Air Conduit 400 and system housing 500, while FIG. 3 illustrates airflow through the system. The Pressurized Air Conduit 400 maintains the volume of air in the system. Air enters the Pressurized Air Conduit 400 after the Electricity-Generating Turbine Corridor 300 and is redirected to the beginning of the system at the Multiple-Compression Chamber 100 where it may assist with rotation of the Air Intake Turbines 120. If the particular system layout results in excess air pressure after the Electricity-Generating Turbine Corridor 300, such as when only one set of Micro-compression Turbines 310 is utilized, decompression vents 410 may be incorporated into the Pressurized Air Conduit 400 and/or system housing 500.

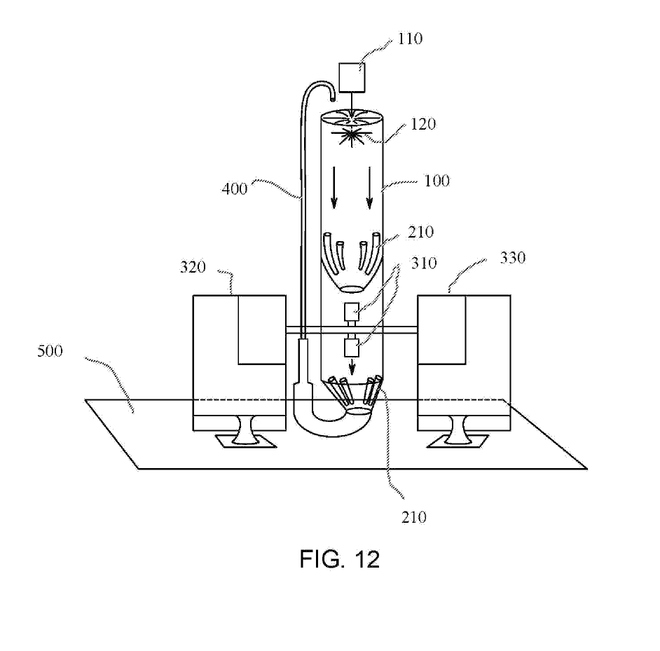

FIG. 12 shows an alternative embodiment Air Powered Electricity Generating System wherein the Multiple-Compression Chamber 100 is oriented vertically on a platform. In this manner, the stabilizing motor 320 and the generator 330 may be placed on the platform for support, with the Pressurized Air Conduit 400 travelling substantially vertically to supply returned air. When oriented in this manner, the system may be easily transported and installed on a surface to take up less room.

The Air Powered Electricity Generating System 900, the starter motor 110 for the Multiple-Compression Chamber 100 and stabilizing motor 320 for the Electricity-Generating Turbine Corridor 300 must be started at the same time. The two motor are controlled by an adjusted frequency drive at 2:1 ratio so that the starting motor 110 will run at 3,600 rpm when the stabilizing motor 320 is at 1,800 rpm. The reactor multiplies energy by converting wind, mechanical, electrical and pneumatic energy into electrical energy, resulting in a 250 kW output with a mere 150 kW input. This constant motion of pressurized air being recycled and focused on the Air Intake Turbines 120 and Micro-compression Turbines 310 help to reverse the input/output ratios of the energy used and creates an inverted energy balance where less electricity is input into the system as more electricity output from the system.

Testing of a prototype conducted by an independent electrical engineer in the field of power distribution and energy management revealed the following results:

| | | | | Input | |
|---|---|---|---|---|---|
| Connected | 480 v-3ph | Reactor | Reactor | Power | |
| Resistive | Utility, “Sce”, | Output | Motor Input | At 85% | |
| Load | Input Current | Voltage | Speed | P.F. | Output |
| (Kw) | (Amps) | (Volts) | (Rev./Min.) | (Kw) | Efficency |
| 0.0 | 81.4 | 410.0 | 2900 | 57.46 | N/A |
| 50.0 | 127 | 410.0 | 2900 | 89.64 | 55.8% |
| 100.0 | 173 | 410.0 | 2900 | 122.11 | 81.9% |
| 150.0 | 223 | 410.0 | 2900 | 157.4 | 95.3% |
| 175.0 | 244 | 410.0 | 2900 | 172.22 | 101.6% |
| 200.0 | 269 | 410.0 | 2900 | 189.87 | 105.3% |

Initially, an output efficiency of 55.8% illustrates an energy loss at 89.64 KW input and 50 KW output. As the input is increased, the power output and efficiency also increases. When the input exceeds 172,22 KW, the efficiency exceeds 100% at 175 KW output. The results suggest that the reactor may output 200 KW using 189.87 KW input (from both motors), without considering power losses due to cable resistance and un-captured wind.

When ambient air is compressed and forced into the electricity generating turbines, the compressed air is the catalyst that unifies the other energies to create an inverted energy balance, which uses less energy and produces more energy. Compressed air by itself cannot use less energy to generate more energy.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may he made thereto without departing from the spirit and scope of the invention. Accordingly, it is to be understood that the present invention has been described by way of illustration and not limitation.

What is claimed is:

1. An air powered electricity generating system, comprising:
a system utilizing electrical energy to create wind energy, the wind energy being compressed in a multi-compression chamber to produce pneumatic energy, the pneumatic energy being transformed into mechanical energy to produce electrical energy in an electricity-generating turbine corridor;
wherein ambient air is drawn into a system housing;
wherein ambient air is recycled back into the system housing;
wherein demand for electrical input is reduced as pneumatic energy is produced; and
wherein overall demand for electrical input to maintain pneumatic energy production is less than the system's energy output over time.

2. The system of claim 1, wherein the air powered electricity generating system comprises:
at least one multi-compression chamber, the multi-compression chamber having at least one starter motor, at least one air intake turbine, and at least one intake turbine shaft connecting the at least one starter motor to the at least one air intake turbine;
at least one electricity-compression turbine corridor having a plurality of concaved micro-compression turbines, at least one stabilizing motor for assisting at least one generator to maintain constant and balanced rotation, and to minimize load on the plurality of micro-compression turbines, at least one electricity-generating turbine corridor shaft upon which the plurality of Micro-compression turbines are mounted and which connects the at least one stabilizing motor and at least one generator, and at last one system housing.

3. The system of claim 2, wherein the case of multiple air intake turbines, at least one air intake turbine draws in air and at least one other air intake turbine pressurizes the air.

4. The system of claim 2, wherein the air intake turbine includes one blade with at least one flange.

5. The system of claim 2, wherein the air intake turbine includes at least one blade with at least one cap.

6. The system of claim 2, further comprising at least one Jet-Propulsion Corridor comprising a plurality of jet nozzles;

7. The system of claim 2, further comprising at least one pressurized air conduit.

8. The system of claim 7, further comprising at least one decompression vent.

9. The system of claim 2, wherein the at least one Multi-Compression Chamber comprises at least one ambient air vent.

10. The system of claim 2, wherein the at least one starter motor maintains a constant rotation of the at least one air intake turbine.

11. The system of claim 10, where in the at least one starter motor is initially powered by an external source, or a battery, until the system begins power generation, wherein the at least one starter motor is powered by electricity generated by the at least one generator.

12. The system of claim 2, wherein the at least one micro-compression turbine comprises metal plates shaped like sails.

13. The system of claim 12, wherein the at least one micro-compression turbine comprises at least one side flange.

14. The system of claim 12, wherein the at least one micro-compression turbine comprises a bottom flange that partially covers the sail shape.

15. The system of claim 12, wherein the at least one micro-compression turbine comprises a bottom flange that extends distally away from the sail shape.

16. The system of claim 2, wherein the jet propulsion nozzles are directed toward the concaved surface of the micro-compression turbines.

17. The system of claim 2, wherein a secondary nozzle, between the jet propulsion nozzles and micro-compression turbines, is directed to the concaved surface of the micro-compression turbines.

18. The system of claim 2, wherein multiple sets of Micro-compression Turbines with stabilizing motor and generator are placed in series to achieve greater power output.

19. The system of claim 2, wherein multiple sets of Micro-compression Turbines are placed in parallel to achieve greater power output.

20. The system of claim 2, wherein multiple sets of Micro-compression Turbines with stabilizing motors and generators are placed in two or more levels to achieve greater power output.

21. The system of claim 2, wherein multiple sets of Micro-compression Turbines are placed in and in two or more levels to achieve greater power output.

22. The system of claim 2, wherein the at least one starter motor and the at least one stabilizing motor are controlled by at least one variable frequency drive.

23. The system of claim 22, wherein the one variable frequency drive is adjusted at a 2:1 ratio so that the starter motor will run at 3,600 rpm when the stabilizing motor is at 1,800 rpm.
